(19) United States
(12) Patent Application Publication
(10) Pub. No.: US 2004/0240417 A1
(43) Pub. Date: Dec. 2, 2004

(54) Repeater remote control system and method in mobile communication system

(76) Inventor: Jin Hyun Kim, Gyeongsangbuk-do (KR)

Correspondence Address: FLESHNER & KIM, LLP, P.O. Box 221200, Chantilly, VA, 20153-1200, US

(21) Appl. No.: 10/622,112

(22) Filed: Jul. 18, 2003

(30) Foreign Application Priority Data
May 27, 2003 (KR) 10-2003-0033708

(51) Int. Cl. H04Q 7/24

(52) U.S. Cl. 370/338; 370/395.2

(57) ABSTRACT

A system and method for remotely controlling one or more repeaters in a mobile communication system includes a remote control server that conducts remote control of the one or more repeaters through packet data transmissions using a mobile IP protocol. The system also includes data terminal equipment that, according to a request of the repeater(s) or the remote control server, establishes connection between the repeater(s) and the remote control server by interworking with the mobile communication network. After the link is established, the data terminal equipment bypasses the received packet data to the repeater or to the remote control server through the IP network. In accordance with the same or another embodiment, the remote control server establishes links to the one or more repeaters with SMS messages or wireless modem ring signals transmitted through the mobile communication network and the data terminal equipment.

### BACKGROUND OF THE INVENTION

1. Field of the Invention

The present invention relates to a mobile communication system, and particularly to a system and method for controlling one or more repeaters in a mobile communication system.

2. Background of the Related Art

In a mobile communication system, a repeater is installed in a radio shadow area to connect the radio shadow area to a base station, so that mobile communication may be made possible even in areas where the base station's radio signal does not reach. Thus, the repeater expands the coverage of a base station.

The repeater may be characterized either as an RF (Radio Frequency) repeater or an optic repeater depending on its solution method. An RF repeater receives signals transmitted from a base station antenna with a donor antenna inside the RF repeater, amplifies the signal to a certain level, and then radiates it to the service antenna. An optic repeater converts signals transmitted from a base station into optical signals through coupling and sends the converted signal to a remote slave unit. The slave unit then converts the optical signals into electric signals, amplifies them, and radiates the amplified signals through an antenna.

Because repeaters are installed and used widely in shadow areas of a mobile communication system's service area and because it is important to repair and manage the repeaters properly to provide communication services of good quality, mobile communication business entities operate network management systems for integrated management of multiple repeaters in a certain service area and conduct remote control of such repeaters.

FIG. 1 is a block diagram illustrating the network structure of a related-art system for remote control of a repeater. As illustrated, the repeater remote control system comprises a repeater 10, a data terminal equipment (DTE) 20, a mobile communication network 30, and a remote control server 40.

If the repeater 10 is an RF repeater, the repeater 10 receives through its antenna 11 signal transmitted from the base station 31's antenna, amplifies the signal to a certain level at its RF module 12 and radiates the signal again through its antenna 11. If any disorder or performance problem occurs during the operation, the repeater 10 reports its state to the remote control server 40 of the network management system (not shown in the drawing) through the data terminal equipment 20 or receives control commands for the relevant situation.

The control unit 13 within the repeater 10 conducts control and state management of the RF module 12, and conducts control to process state information concerning the repeater 10.

The data terminal equipment 20, which is combined with the repeater 10 to form one body or is connected to the repeater 10 by cable, acts as a terminal transmitting or receiving state information and control commands between the repeater 10 and the remote control server 40. If a wireless modem is used as the data terminal equipment 20, such data terminal equipment 20 transmits and receives data of the short message service (SMS) type to and from the remote control server 40 through the mobile communication network. On the other hand, if a dial-up modem is used, the data terminal equipment 20 transmits and receives data through a cable telephone network (not shown in the drawing) of the PSTN (Public Switched Telephone Network).

The remote control server 40 within the network management system (not shown in the drawing) conducts remote control of multiple repeaters 10 within the relevant service area by receiving state information of the data terminal equipment 20 and of the repeater 10 or transmits control commands of the administrator of the network management system (not shown in the drawing) through the mobile communication network 30 or through a cable telephone network (not shown in the drawing).

In other words, because the RF repeater usually uses a wireless modem for the data terminal equipment 20, if there occurs any disorder or performance problem during the operation, the data terminal equipment 20 converts the state information received from the repeater 10 into the format of the SMS and transmits the message to the remote control server through the mobile communication network comprising a base station 31, a control station 32, a switching equipment 33, an SMSC (Short Message Service Center) 34 and an HLR (Home Location Register) 35. The remote control server 40 which received the message 40 processes the message and if it is necessary to transmit control commands, create control commands in the format of the SMS and transmits it through the mobile communication network 30.

Then, the data terminal equipment 20 receives control commands in the format of the SMS from the remote control server 40 through the mobile communication network 40, converts the format and transmits it to the repeater 10. The repeater 10 then resolves the above-mentioned disorder of performance problem according to the converted control commands.

The protocol stack of the related art system is illustrated in FIG. 2. The repeater 10 and the data terminal equipment 20 are connected in series at the physical layer according to the RS-232C standard. As the network layer, the “LGE Protocol 2,” which may be used for one to one (1:1) communication, is adopted. Further, as the physical layer, Air I/F, connects the data terminal equipment 20 and the base station 31. Data are transmitted and received between the data terminal equipment 20 and the base station 31 through the SMS messages according to the “LGE Protocol 1” which may enable one to n (1:n) communication to the network.

The data terminal equipment 20 makes the data conversion between the LGE Protocol 1 and the LGE Protocol 2 in between the repeater 10 and the base station 31. The LGE Protocol 1 and the LGE Protocol 2 are communication protocols provided by a repeater manufacturer or a mobile communication system manufacturer.

Specifically, the LGE Protocol 1 defines a packet of the format illustrated in FIG. 3, transmits the state information and alarm information, etc. of the repeater 10, that the data terminal equipment 20 has received through the LGE Protocol 2, to the remote control server 40 interworking with the mobile communication network 30 comprising the base station 31. Further, the LGE Protocol 1 defines response messages or control command messages received from the remote control server 40 in response to the above-described transmission. In this manner, the one to n (1:n) communication is made possible. The above-mentioned defined packet comprises: a header field including a repeater ID field indicating the unique identification number of the repeater 10 connected to the data terminal equipment 20, a sequence number field representing the sequence number assigned for the transmitted packets, a data code field indicating the type of data carried by the transmitted packets, a data size information field indicating the size of the data field, and a repeater type field containing information on the repeater type; data field; and packet end-point field, etc.

As illustrated in FIG. 4, the LGE Protocol 2 defines a packet comprising a packet start-point field indicating the start of the packet, a command code field indicating the type of command contained in the data field of the packet, a data size information field indicating the size of the data field, a data field with variable size in which the data to be transmitted are contained, a CRC (Cyclic Redundancy Check) field for detecting errors, if any, in the packet, and a packet end-point field. The LGE Protocol 2 conducts one to one (1:1) communication for the data terminal equipment's monitoring the repeater 10's state.

In the above-described repeater remote control system of the related art, if overload occurs in the short message service center (SMSC) when data are transmitted and received through the SMS protocol between the data terminal equipment connected to the repeater and the remote control server of the network management system, the message transmission will be delayed due to the nature of the SMS protocol and thus real-time data transmissions become impossible. Moreover, because the size of data that can be included in a short message is limited, when the remote control for the remote control server's receipt of the state information of repeaters or transmission of control commands, only basic monitoring and control functions may be conducted.

### SUMMARY OF THE INVENTION

An object of the invention is to solve at least one of the above problems and/or disadvantages and to provide one or more advantages described hereinafter.

Another object of the present invention is to provide an improved remote control system and method for conducting remote control of one or more repeaters installed within a service area of a mobile communication system.

According to one embodiment, the present invention provides a remote control server which establishes connection to one or multiple repeaters by SMS (Short Message Service) messages or a wireless modem's ring signals through a mobile communication network according to relay of a data terminal equipment, and when the link is established transmits and receives packet data to and from one or multiple repeaters using mobile IP protocol interworking with the IP network, thus conducting the remote control.

A repeater remote control system in a mobile communication system according to one embodiment of the present invention comprises: a remote control server that conducts remote control of one or multiple repeaters through packet data transmission and receipt by using mobile IP protocol; and a data terminal equipment that, according to a request of the repeater or the remote control server, establishes connection between the repeater and the remote control server by interworking with the mobile communication network and, after the link has been established, bypasses the received packet data to the repeater or to the remote control server through the IP network. The remote control server conducts remote control after establishing links to said one or multiple repeaters through the data terminal equipment by matching with a short message service center (SMSC) within the mobile communication network. Alternatively, the remote control server conducts remote control after establishing links to one or multiple repeaters through the data terminal equipment by matching with the IWF (InterWorking Function) within the mobile communication network. The data terminal equipment is preferably controlled according to the IS-707 rules.

A repeater remote control method in a mobile communication system according to another embodiment of the present invention comprises one or multiple repeaters' which establish a link to a remote control server through the relay of a data terminal equipment. When the link has been established, remote control is conducted between the repeaters and the remote control server by transmitting and receiving packet data using mobile IP protocol on the IP network.

Establishment of the link comprises: the repeaters' checking whether the data terminal equipment is in the normal state, if the data terminal equipment is in the normal state, the one or multiple repeaters' requesting connections to the remote control server by transmitting remote control server connection information regarding the remote control server to the data terminal equipment; the data terminal equipment's conducting the procedure for approval of connection with the remote control server through the mobile communication network according to said remote control server connection information; and when the data terminal equipment receives a message indicating the remote control server's connection approval, establishing link by transmitting the received message to the repeaters. The remote control server connection information preferably comprises at least one of the following: phone number; IP address; or server port information of the remote control server to be connected.

Conducting remote control between the repeaters and the remote control server comprises, after link is established, checking the version of software embedded in said one or multiple repeaters and updating it with new version. Conducting remote control between the repeaters and the remote control server further comprises: checking whether there is disconnection request from the remote control server; and if there is no disconnection request from the remote control server, unless there is data transmission with the remote control server during certain standby time, clearing the connection automatically.

Automatic disconnection from the remote control server comprises, after the disconnection, checking whether there exists any data that has not been transmitted yet to the remote control server from the relevant repeater and if there exists such data, making connection request again to the remote control server.

A repeater remote control method in a mobile communication system according to another preferred embodiment of the present invention comprises: a remote control server's establishing links to one or multiple repeaters through the relay of a data terminal equipment; and when the links are established, selecting a management mode and conducting remote control between said one or multiple repeaters and the remote control server by transmitting and receiving packet data using mobile IP protocol on the IP network according to the selected management mode. The link is established by the remote control server's transmitting SMS messages upon matching with the SMSC (Short Message Service Center) within the mobile communication network. Alternatively, the link is established by the remote control server's transmitting wireless modem's ring signal upon matching with the IWF (InterWorking Function) within the mobile communication network.

Establishment of the link comprises: checking repeater ID and connection state of the relevant repeater by loading the stored repeater management table; and if link has not been established with the relevant repeater, establishing link by transmitting SMS messages or ring signal to the data terminal equipment connected to said repeater. The repeater management table preferably comprises one or more of the following: repeater ID field, data terminal phone number field, connection state field, connection ID field, field of IPs assigned to the data terminal equipment, and download status field.

Selecting a management mode and conducting remote control between the remote control server and said one or multiple repeaters may be performed by conducting remote control between the remote control server and the one or multiple repeaters while the data terminal equipment collects detailed status information of the repeaters connected to the data terminal equipment, such as the particular cause of an alarm occurring at a repeater and information on the internal location of the repeater where the alarm has occurred. This information may then be reported to the remote control server at each detailed information report time of a certain period.

Alternatively, selecting a management mode and conducting remote control between the remote control server and said one or multiple repeaters may be performed by conducting remote control between the remote control server and the one or multiple repeaters while the data terminal equipment collects only essential information required for repeater management. Remote control may also include information on whether repeaters connected to the data terminal equipment are in operation and the software version information. The information is then reported to the remote control server at each essential information report time of certain period.

Conducting remote control between the remote control server and the one or multiple repeaters comprises: the remote control server's checking whether there is a disconnection request from said one or multiple repeaters; and if there is no disconnection request from said one or multiple repeaters, unless there is packet data transmission or receipt to or from said one or multiple repeaters for a certain standby time, clearing the connection automatically.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating a system in the related art for performing remote control of repeaters.

FIG. 2 is a layer diagram illustrating protocol stacks of a repeater and a data terminal equipment in a repeater remote control system of the related art.

FIG. 3 illustrates a packet according to the LGE Protocol 1 in a repeater remote control system of the related art.

FIG. 4 illustrates a packet according to the LGE Protocol 2 in a repeater remote control system of the related art.

FIG. 5 is a block diagram illustrating a system of the present invention.

FIG. 6 is a flow chart of the procedure in which a repeater attempts to establish connection to the remote control server in a repeater remote control method in a mobile communication system according to the present invention.

FIG. 7 is a flow chart of the procedure in which the remote control server attempts to establish connection to repeaters in a repeater remote control method in a mobile communication system according to the present invention.

FIG. 8 is a flow chart of the procedure in which the remote control server of FIG. 7 attempts to establish connection to one repeater or multiple repeaters by using a repeater management table.

FIG. 9 is a layer diagram illustrating protocol stacks of a repeater and a data terminal equipment in a repeater remote control method in a mobile communication system according to the present invention.

FIG. 10 is a block diagram illustrating constitution of the remote control server in a system of the present invention.

FIG. 11 illustrates constitution of the repeater management table in a repeater remote control method in a mobile communication system according to the present invention.

FIG. 12 is a signal flow diagram illustrating flow of signals at the time when a repeater attempts to establish connection to the remote control server in a repeater remote control method in a mobile communication system according to the present invention.

FIG. 13 is a signal flow diagram illustrating flow of signals at the time when the remote control server attempts to establish connection to repeaters in a repeater remote control method in a mobile communication system according to the present invention.

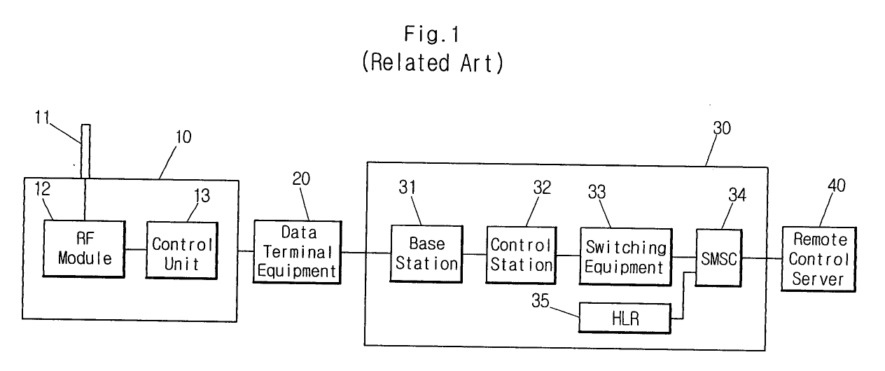

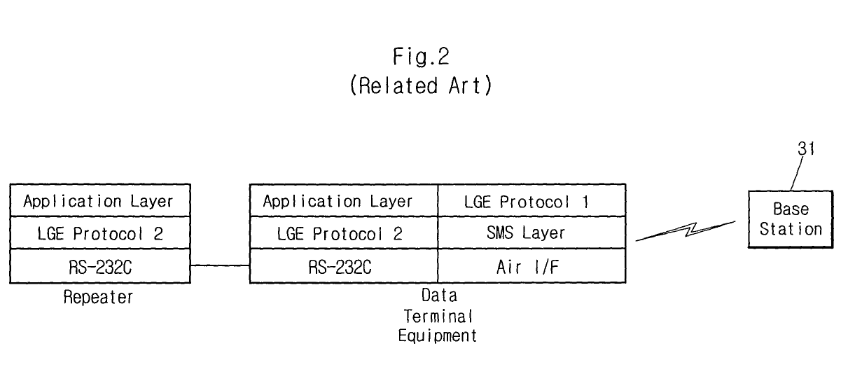

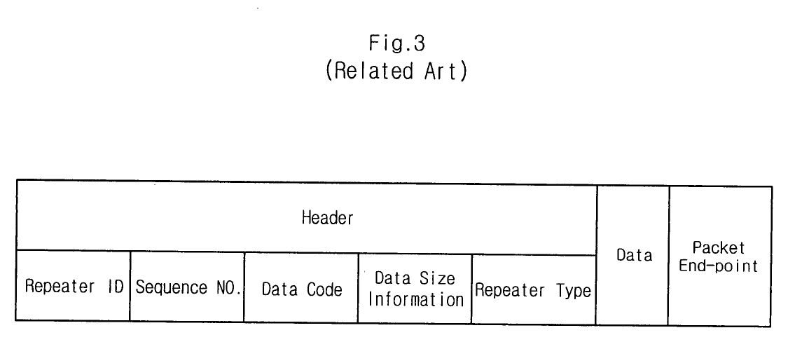

### DETAILED DESCRIPTION OF PREFERRED EMBODIMENTS

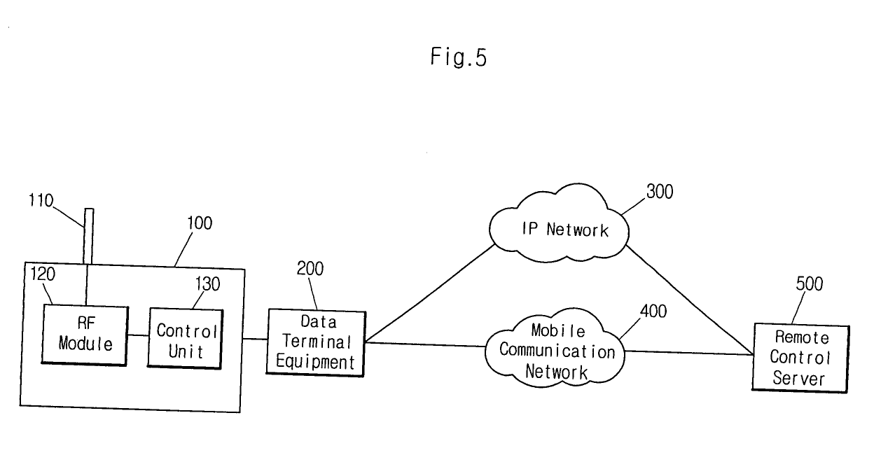

Referring to FIG. 5, a system according to one embodiment of the present invention comprises at least one repeater 100, a data terminal equipment (DTE) 200, an IP network 300, a mobile communication network 400, and a remote control server 500. Although one repeater is shown, multiple repeaters may be included in a relevant service area and controlled by the system of the present invention.

When the remote control server 500 within a network management system (not shown in the drawing) of the mobile communication system conducts remote control of one or more multiple repeaters installed in the relevant service area, the repeaters 100 or the remote control server 500 establish a link with each other through the mobile communication network 400 through the data terminal equipment 200. After a link is established, the data terminal equipment 200 bypasses packet data to be transmitted between the repeater and the remote control server. Thus, data transmission using the mobile IP protocol is enabled between the repeater and the remote control server.

The mobile IP protocol is an Internet protocol developed for the purpose of realizing hand-off communication at the network layer and provides Internet interface and roaming/hand-off service, etc., not only in an IP network or a mobile communication network supporting IMT (International Mobile Telecommunication)-200 service, next generation mobile communication service, and the conventional mobile communication service but also in various wireless networks including wireless LANs. In the present invention, the remote control server 500 within the network management system (not shown in the drawing) conducts remote control of the repeater 100 using the mobile IP protocol interworking with the IP network 300.

As illustrated in FIG. 9, one preferred type of protocol stack used in accordance with the present invention is connected between repeater 100 and data terminal equipment 200 in series at the physical layer according to the RS-232C standard. EIA/TIA's recommendation IS-707, which is for wireless data service, is adopted as the data link layer to control the data terminal equipment 200. Thus, each equipment manufacture does not need to develop its own protocol to control data transmitted between the repeater 100 and the data terminal equipment 200. As the network layer, the present invention adopts the LGE Protocol 2, through which one to one (1:1) communication is possible.

The base station within the IP network 300 or the mobile communication network 400 and the data terminal equipment 200 are connected by wireless interface (Air I/F) as the physical layer. Further, the mobile IP protocol is used as the network layer for data transmission between the repeater 100 and the remote control server 500.

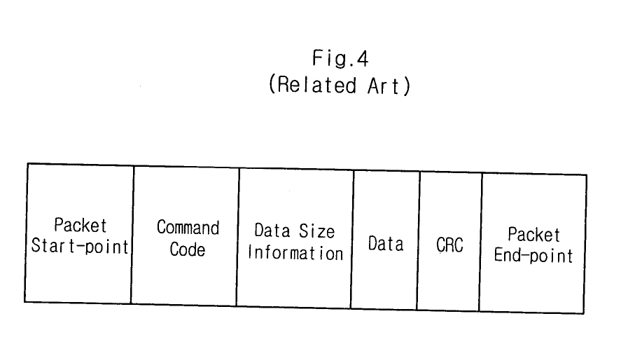

The LGE Protocol 2 is a type of communication protocol provided by the manufacturer of the repeater 100 or the mobile communication system manufacturer and, as illustrated in FIG. 4, defines a packet comprising a packet start-point field indicating the start of a packet, a command code field indicating the type of a command included in the data field of the packet, a data size information field indicating the size of the data field, a data field in which variable data to be transmitted are included, a CRC (Cyclic Redundancy Check) field for detection of errors in the packet, and a packet end-point field indicating the end of the packet. Through the LGE Protocol 2, the data terminal equipment 200 monitors the state of the repeater 100.

Assuming that the repeater 100 of the present invention is an RF Radio Frequency) repeater, the repeater 100 is preferably installed in electric wave shadow area to connect the base station and the electric wave shadow area according to the control of the control unit 130, so that mobile communication may be possible even in places where the base station's electric wave is not delivered through the antenna 110 or the RF module 120, thereby expanding the base station coverage. Furthermore, at the time of initial operation or if any disorder occurs or if there exist data to be transmitted, the repeater 100 transmits the remote control server connection information, which has been stored, to the data terminal equipment 200 and then establishes a link to the remote control server 500 within the network management system (not shown in the drawing) through the mobile communication network through the data terminal equipment 200. Thereafter, when the link is established upon the remote control server 500's connection approval, packet data for state information and alarm information of the remote control server 500 and the repeater 100 or for control commands of the remote control server 500 are transmitted and received.

The data terminal equipment 200, which is combined with the repeater 100 to form one body or connected with the repeater 100 by a cable, relays connection for communication between one or multiple repeaters 100 and the remote control server 500 through the mobile communication network. When the connection is established, the data terminal equipment bypasses packet data to be transmitted between the repeater(s) and the remote control server.

If a wireless modem is used for the data terminal equipment 200, the repeater and the remote control server are connected by SMS (Short Message Service) messages through the mobile communication network 400. On the other hand, if a dialup modem is used for the data terminal equipment, the connection is attempted through a cable telephone network (not shown in the drawing) of the PSTN (Public Switched Telephone Network). In this preferred embodiment of the present invention, a wireless modem is used for the data terminal equipment 200.

For remote control of multiple repeaters 100 installed within the service area of the mobile communication system, the remote control server 500 within the network management system (not shown in the drawing) establishes a link by attempting connection to one or multiple repeaters 100 through the mobile communication network 400 through the data terminal equipment 200. When the link is established, the remote control server receives state information or alarm information of the repeaters 100 or transmits control commands of the network management system administrator using the mobile IP protocol, thereby conducting the remote control of one or multiple repeaters 100.

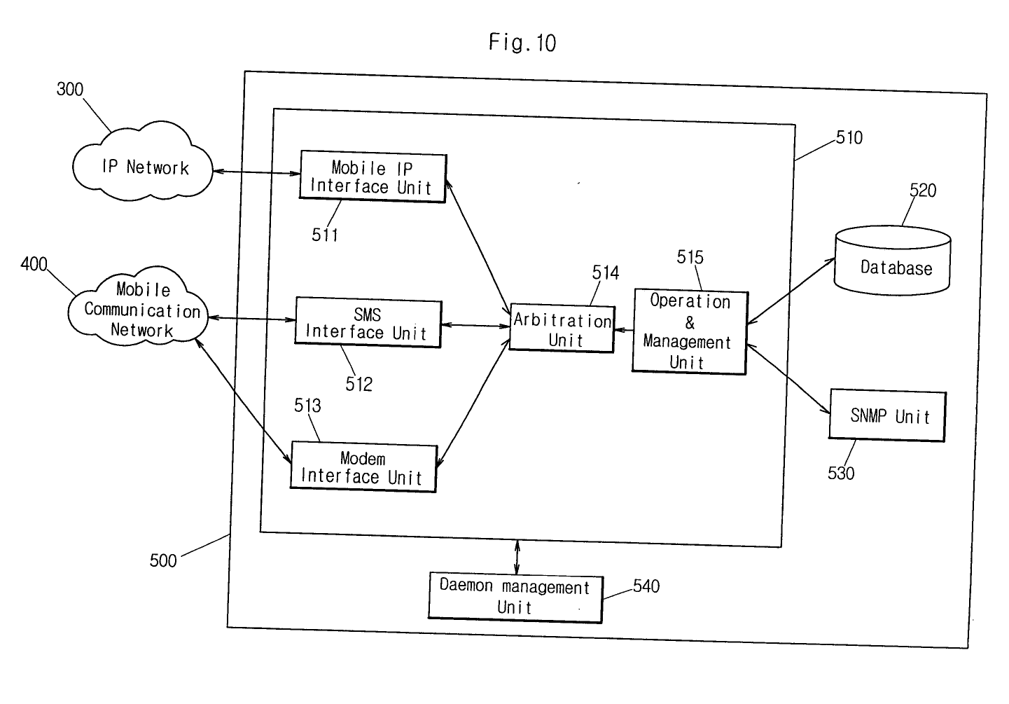

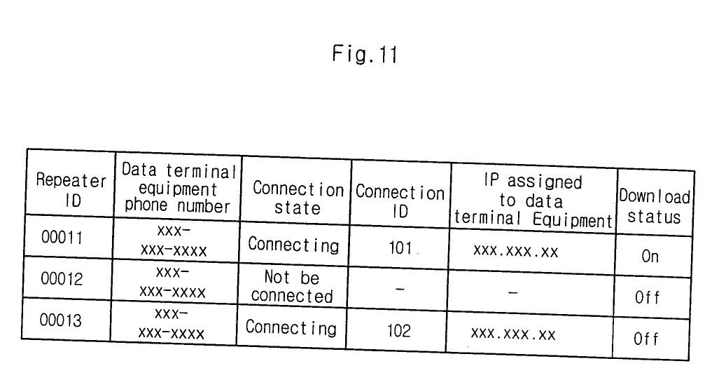

FIG. 10 shows one possible configuration remote control server 500. As shown, this server comprises a control unit 510, a database 520, an SNMP (Simple Network Management Protocol) unit 530, and a Daemon management unit 540. The arbitration unit 514 within the control unit attempts connection to the repeater 100 and the data terminal equipment 200 for packet data transmission through relevant interface units 511˜513 matched to the IP network 300 or the mobile communication network 400 according to the administrator's specification. After the connection is established, the operation and management unit 515 analyzes the state information and alarm information received from the repeater 100, processes the relevant procedures and control commands of the administrator, and transmits the information to the repeater 100 through a relevant one of the interface units 511˜513 and the IP network 300 or the mobile communication network 400 according to control of the arbitration unit 514.

If the arbitration unit 514 operates with the mobile communication network 400, the SMS interface unit 512 is matched with the SMSC (Short Message Service Center) (not shown in the drawing) and the modem interface unit 513 is matched with the IWF (InterWorking Function) (not shown in the drawing) to establish a link to one or multiple repeaters with SMS messages or ring signals. After the link is established, the arbitration unit 514 works in connection with the IP network 300. At this time, the mobile IP interface unit 511 is matched with the GGSN (Gateway GPRS Support Node) (not shown in the drawing) or the PDSN (Packet Data Serving Node) (not shown in the drawing) within the IP network, to transmit and receive packet data using the mobile IP.

The operation and management unit 515 takes steps required to obtain statistics on the state information and alarm information about the repeater 100 received through the interworking with the database 520 and downloads the newest version of software stored in the database 520 at the repeater 100, if it is necessary to have the software embedded in the repeater downloaded.

The database 520 stores various software necessary for the system operation and statistics data on the repeater 100's state information and alarm information and manages such data while interworking with the operation and management unit 515. The SNMP unit 530 compiles and manages network management information generated in the course of conducting communication with the repeater 100 through the mobile IP protocol. The Daemon management unit 540 monitors and manages Daemon related to operation of the control unit 510.

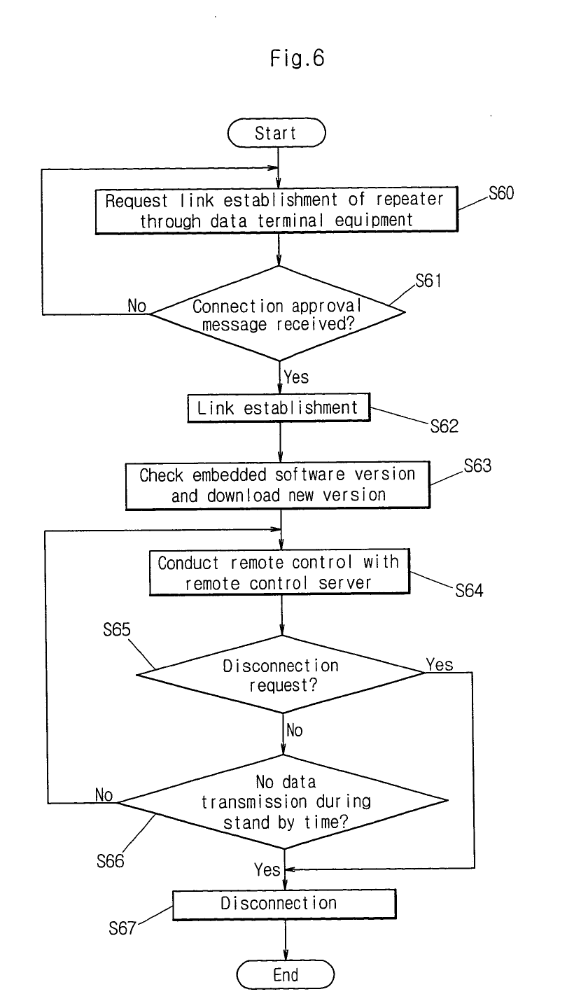

Operation of the repeater remote control system according to the aforementioned embodiment of the present invention will now be explained. In the case where the repeater 100 attempts connection to the remote control server 500, as illustrated in FIG. 6, the repeater requests a link establishment to the remote control server 500 through the data terminal equipment 200 at the time of the repeater 100's initial operation, or when a disorder occurs in the repeater 100 or if there is data to be transmitted (S60).

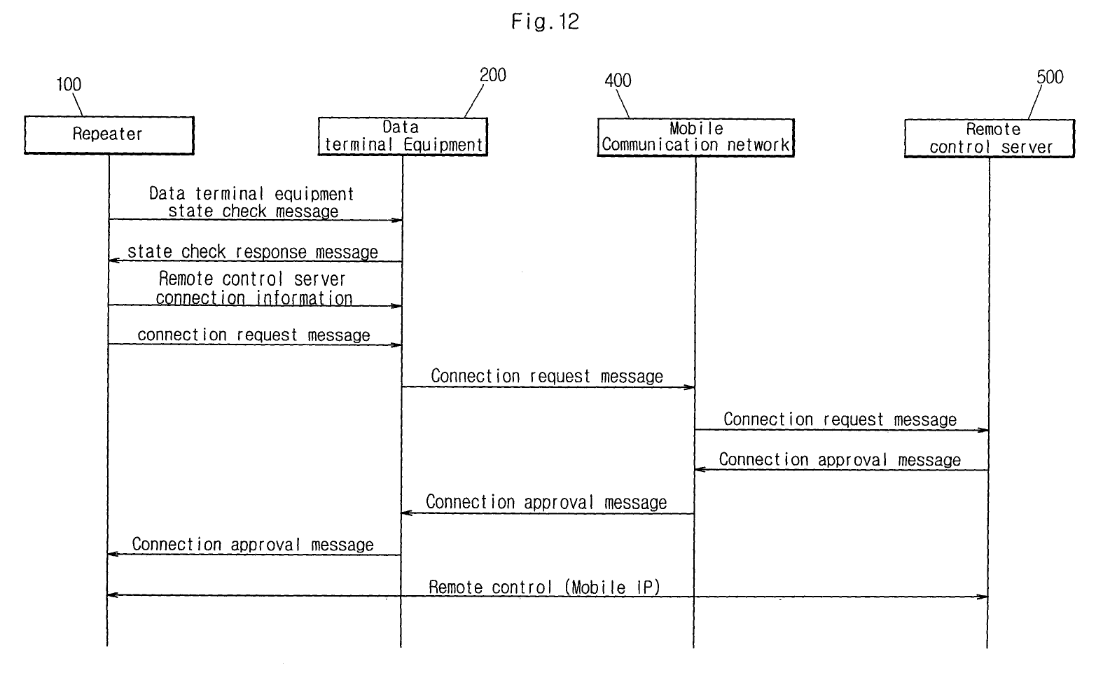

More specifically, as illustrated in FIG. 12, the repeater 100 confirms that the data terminal equipment 200 is in the normal state through a data terminal equipment state check message. The repeater 100 then requests connection to the remote control server 500 by transmitting to the data terminal equipment 200 the remote control server connection information including phone number, IP address and server port information, etc. of the remote control server 500 to be connected.

Then, according to the remote control server connection information, the data terminal equipment 200 conducts procedures to approve the connection to the remote control server 500 with SMS messages or ring signals through the mobile communication network 400. When the data terminal equipment 200 and the repeater 100 receive a connection approval message from the remote control server 500, the link is established among the repeater 100, the data terminal equipment 200 and the remote control server 500 and thus the connection for packet data transmission is completed (S61, S62).

When the link is established, the repeater 100 conducts procedures to renew software by transmitting information on the version of software, that the repeater 100 itself has stored, to the remote control server 500. If there exists a new version of software, the new version of software stored in the database 520 of the remote control server 500 is downloaded in the packet data format using the mobile IP protocol (S63).

When the software renewal is completed, the repeater 100 conducts remote control with the remote control server 500 through the IP network 300 (S64).

The data terminal equipment 200 bypasses packet data received from the repeater 100 or the remote control server 500 without any additional message or protocol conversion and transmits them to the other side, thereby, making it appear that packet data are transmitted and received directly between the repeater 100 and the remote control server 500.

The repeater that conducts the remote control with the remote control server checks whether there is a disconnection request from the remote control server (S65). Even if there is no disconnection request, if there has been no data transmission with the remote control server for certain standby time, the connection is automatically cleared (S66, S67).

The above-described step of automatic disconnection is optional but is preferably implemented in accordance with the present invention to reduce waste of channel resources of the IP network 300 in the case where there is no data transmission while the connection between the repeater and remote control server is maintained. In such a case, after the standby time passes, the connection between the repeater and remote control server is cleared automatically. After such disconnection, the repeater checks whether there are any data that should have been transmitted. If such data exists, the repeater attempts connection to the remote control server again.

If the connection between the remote control server and the repeater is automatically cleared because the standby time has passed without data transmission due to the IP network 300's environment, because there would often exist data to be transmitted in the repeater, the repeater checks whether there exist data that have yet to be transmitted after the disconnection and then attempts connection to the remote control server 500 if there indeed exist such data in the repeater.

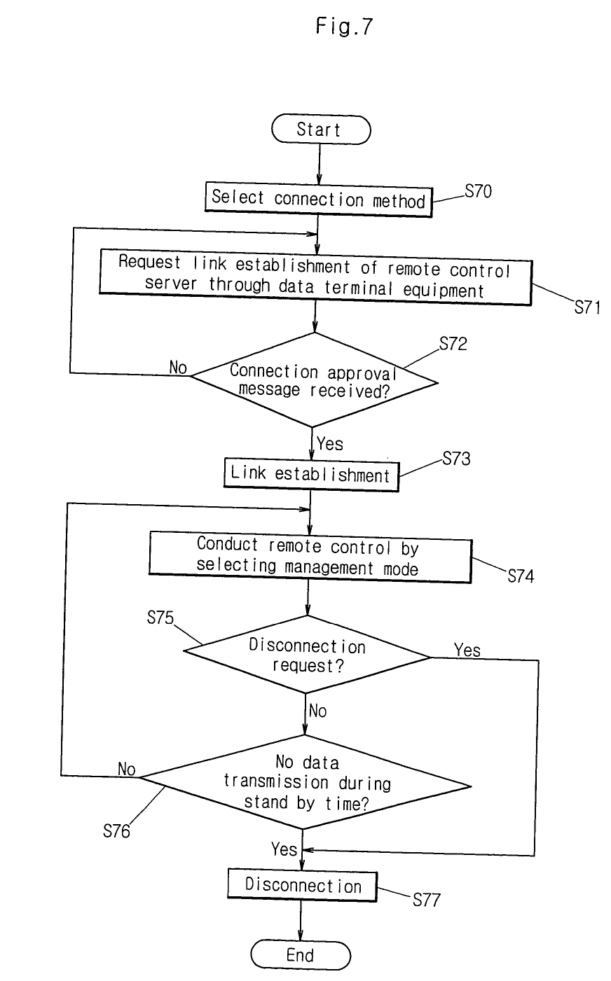

On the other hand, in the case where the remote control server attempts connection to the repeater, as illustrated in FIG. 7, for the remote control of one or multiple repeaters 100 according to the specification of the network management system's administrator, the remote control server 500 requests link establishment to the one or multiple repeaters 100 while interworking with the mobile communication network 400 through the data terminal equipment 200 according to the connection method selected by the administrator (S70, S71).

Depending on the environment of the relevant system or the mobile communication network 400, for the connection to the one or multiple repeaters, the administrator may select the method of transmitting SMS messages by matching with the SMSC (Short Message Service Center) within the mobile communication network 400 through the SMS interface unit 512 or the method of transmitting ring signals of a wireless modem by matching with the IWF (InterWorking Function) within the mobile communication network 400 through the modem interface unit 513.

During the system's normal operation of the system, the administrator of the network management system may check the state of a certain repeater or multiple repeaters selected for the check. More specifically, the administrator may set up the system so that the relevant certain repeater or repeaters may report its or their states every state reporting time of a certain period or at a specific time point.

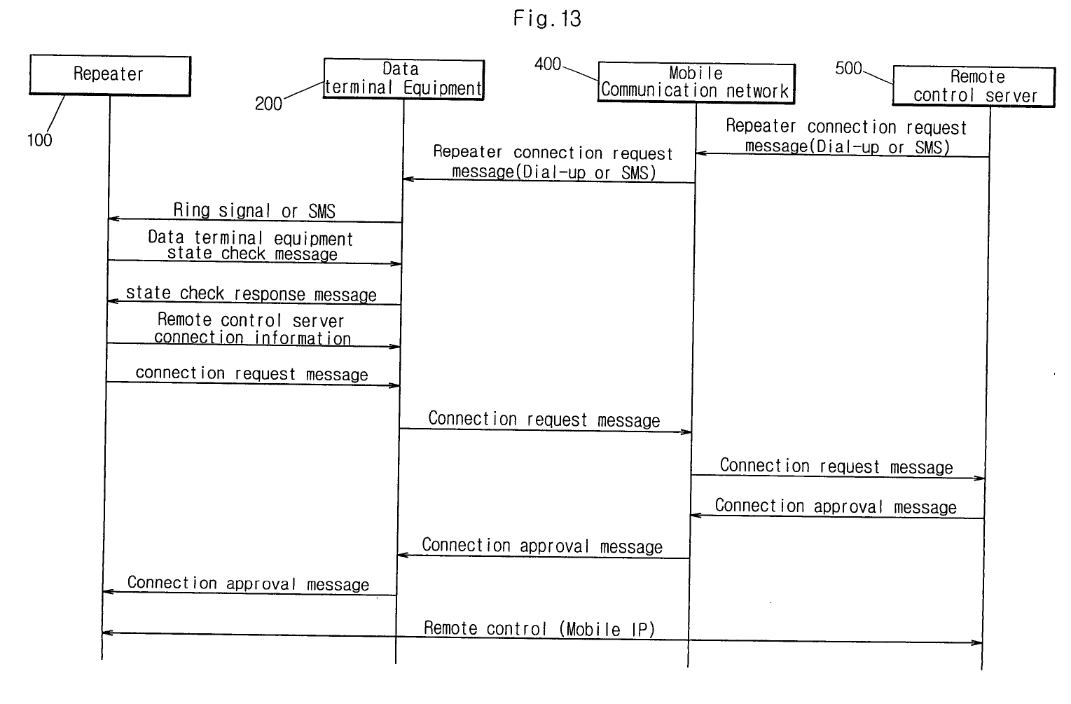

If the remote control server 500 attempts connection to the one or multiple repeaters through the mobile communication network, as illustrated in FIG. 13, the remote control server 500 transmits a connection request message to the repeater 100 via the SMSC (Short Message Service Center) within the mobile communication network matched to the remote control server and the data terminal equipment 200 through the SMS (Short Message Service) protocol. The repeater(s) that received the messages requests connection with the remote control server. In the case where the remote control server attempts connection to one or multiple repeaters by matching with the mobile communication network 400 including the IWF (not shown in the drawing) through the internal modem interface unit 513, the remote control server transmits ring signals through the modem to the repeater(s) via the mobile communication network 400 including the IWF and the data terminal equipment 200. The repeater(s) then request connection to the remote control server.

The data terminal equipment 200 receives remote control server connection information from the one or multiple repeaters and thus conducts a procedure for the approval of the connection to the remote control server according to the connection method selected by the remote control server.

When the remote control server attempts connection to a selected repeater or repeaters, the control unit 510 within the remote control server uses the repeater management table stored in the database 520. The repeater management table is a table for managing and remote-controlling multiple repeaters in the service area of a network management system.

As illustrated in FIG. 11, the repeater management table preferably comprises: repeater ID field setting forth unique IDs assigned to the repeaters, a data terminal phone number field setting forth phone number of the data terminal equipment required in attempting connection to the relevant repeater through the mobile communication network 300, a connection state field setting forth connection state of the repeater, a connection ID field setting forth identifiers indicating connection state when the data are transmitted to the relevant repeater after the connection to the repeater has been completed, a field of IPs assigned to the data terminal equipment setting forth IP address of the data terminal equipment 200 which will be the destination of the data according to the mobile IP protocol after the connection to the relevant repeater has been completed, and a download status field indicating whether software for the operation of the repeater has been downloaded on the relevant repeater according to the administrator's setup.

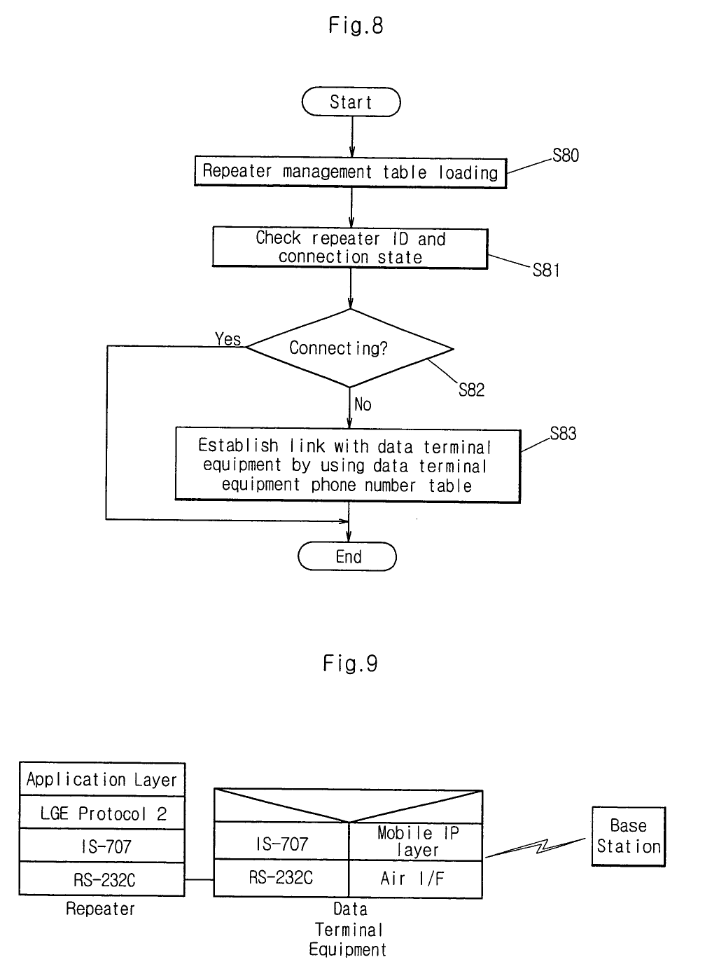

Thus, when the administrator attempts connection to one or multiple repeaters through the remote control server 500, as illustrated in FIG. 8, the control unit 510 within the remote control server loads the repeater management table stored in the database 520 and checks the repeater ID field and the connection state field (S80, S81).

Thereafter, if it is determined that no link has been established with the relevant repeater(s), SMS messages or ring signals are transmitted to the data terminal equipment 200 connected to the relevant repeater(s) using the data terminal phone number field. In this manner, the remote control server may establish links to the repeater(s) and the data terminal equipment 200 (S82, S83).

Then, the repeater(s) receive connection approval messages from the remote control server and a link(s) is established among the repeater, the data terminal equipment 200 and the remote control server. The connection for the packet data transmission is therefore completed (S72, S73). Thereupon, the network management system's administrator selects a management mode and the remote control of the one or multiple repeaters is conducted through the IP network 300 according to the selected management mode (S74).

The administrator of the network management system conducts remote control of the one or multiple repeaters by selecting the state information collection mode and the remote control mode through the remote control server. The state information collection mode is selected by the system administrator in a case where alarm information has been received from the repeater or if the administrator wishes to know more detailed state information of the repeater. In the state information collection mode, the data terminal equipment 200 collects detailed state information about the repeater such as the particularized causes for alarm that has occurred in the repeater connected to the data terminal equipment 200 and the information on the internal location of the repeater where the alarm has occurred, and then reports the collected data to the remote control server every detailed information report time of certain specific period.

On the other hand, the remote control mode is selected when the repeater is in the state of normal operation. In this mode, the data terminal equipment 200 collects only essential information required for management and remote control of the repeater such as the information on whether the connected repeater is in operation and the software version information, etc., and reports the collected data to the remote control server 500 every essential information report time of a certain period which is longer than the period of the detailed information report time.

Thereafter, the remote control server conducting remote control of one or multiple repeaters checks whether there is any disconnection request from the repeater and determines whether to clear the connection or not (S75). Even if there is no disconnection request, if there has been no data transmission to and from the remote control server and the repeater for a certain standby time, the connection is cleared automatically (S76, S77) as with the case where the connection is attempted by one or multiple repeaters.

As explained above, the present invention provides a system and method for the remote control of one or more repeaters installed in a service area of a mobile communication system. The system includes a remote control server which attempts connection and establishes links to one or multiple repeaters with SMS messages or wireless modem ring signals through the mobile communication network. The connection and links are established through data terminal equipment. When these links are established, the remote control server controls one or multiple repeaters by transmitting and receiving packet data to and from the one or multiple repeaters using the mobile IP protocol interworking with the IP network. The present invention therefore advantageously enables two-way communication in which the repeater's state information or alarm information may be received in real time and the remote control server's control commands may be transmitted. Furthermore, because a large amount of data may be transmitted by using packet data according to the mobile IP protocol, the present invention enables the download of software for each repeater and precise management and control from a remote site.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A repeater remote control system in a mobile communication system comprising:
a server that controls at least one repeater through packet data transmissions sent through a mobile IP network; and
a data terminal unit that establishes a first link between said repeater and the server through the mobile IP network.

2. The system of claim 1, wherein the data terminal unit establishes a second link between said repeater and the server by interworking with a mobile communication network.

3. The system of claim 2, wherein after the second link is established, the data terminal unit passes control packet data from the server to said repeater through the mobile IP network.

4. The system of claim 1, wherein said packet data transmissions include an SMS message.

5. The system of claim 1, wherein the server sends said packet data transmissions to said repeater by matching with an IWF (InterWorking Function) within the mobile communication network.

6. The system of claim 1, wherein the data terminal unit is controlled according to an IS-707 standard.

7. A repeater remote control method in a mobile communication system, comprising:
establishing a first link between a server and a data terminal unit through a mobile communication network and a second link between the server and the data terminal unit through a mobile IP network;
transmitting packet data for controlling a repeater from the server to the data terminal unit through the mobile IP network; and
sending the packet data from the data terminal unit to said repeater.

8. The method of claim 7, wherein said establishing the first link comprises:
checking whether the data terminal unit is in a normal state, said checking performed by the repeater;
if the data terminal unit is in the normal state, transmitting server connection information from the repeater to the data terminal unit;
conducting a procedure for approval of connection with the server through the mobile communication network based on the server connection information; and
receiving a message indicating the server connection approval and transmitting the received message to the repeater.

9. The method of claim 8, wherein server connection information comprises at least one of a phone number, an IP address, and server port information of the server to be connected.

10. The method of claim 7, further comprising:
checking a version of control software embedded in the repeater; and
updating the repeater with a new version of the control software.

11. The method of claim 7, further comprising:
checking whether a disconnection request has been sent from the server, said checking performed by the repeater; and
if no disconnection request has been sent, unless there is data transmission with the server during a standby time, automatically disconnecting at least one of the first link and second link.

12. The method of claim 11, wherein said automatic disconnection comprises:
after the disconnection, checking whether data exists that has not yet been transmitted to the server from the repeater, said checking being performed by the repeater; and
if such data exists, sending a connection request again to the server.

13. A repeater remote control method in a mobile communication system comprising:
establishing a link between a repeater and a server through data terminal equipment;
selecting a management mode; and
transmitting packet data to the repeater through a mobile IP network including the link based on the selected management mode.

14. The method of claim 13, wherein establishing the link includes transmitting at least one SMS message within the mobile communication network.

15. The method of claim 13, wherein establishing the link includes transmitting a wireless modem ring signal upon matching with an IWF (InterWorking Function) within the mobile communication network.

16. The method of claim 13, wherein establishing the link comprises:
checking an ID and connection state of the repeater by loading a stored repeater management table; and
if the link has not been established with the repeater, establishing the link by transmitting an SMS message or ring signal to the data terminal equipment connected to the repeater.

17. The method of claim 16, wherein said repeater management table comprises one or more of the following: a repeater ID field, a data terminal phone number field, a connection state field, a connection ID field, a field of IPs assigned to the data terminal equipment, and a download status field.

18. The method of claim 13, further comprising:
collecting status information of the repeater connected to said data terminal equipment, and then reporting the status information to the server at an information report time.

19. The method of claim 18, wherein the status information includes information indicative of a cause of an alarm occurring at the repeater and information relating to an internal location of the repeater when the alarm has occurred.

20. The method of claim 13, further comprising:
collecting only information required for repeater management and remote control, and reporting the information to the server at an information report time.

21. The method of claim 20, wherein the information indicates at least one of whether the repeater is in operation and a version of control software in the repeater.

22. The method of claim 13, further comprising:
checking whether a disconnection request has been sent from the repeater, said checking performed by the server; and
if no disconnection request has been sent, unless there is packet data transmission or receipt to or from the repeater within a certain standby time, automatically disconnecting the link.

23. A method for controlling a repeater in a mobile communication system, comprising:
establishing a first link between a server and the repeater, at least a portion of the first link being established over a mobile IP network;
transmitting control information between the server to the repeater over the link.

24. The method of claim 23, wherein the repeater initiates establishing the first link.

25. The method of claim 23, further comprising:
establishing a second link between the server and repeater, wherein at least a portion of the second link is established over a mobile communications network and wherein transmitting the control information is performed after the second link is established.

26. The method of claim 23, wherein the control information is transmitted in a format which complies with an IS-707 standard.

27. The method of claim 23, wherein the first link is established at a time of initial operation of the repeater.

28. The method of claim 23, wherein the first link is established after a disorder occurs in the repeater.

29. The method of claim 23, wherein the first link is established after a determination is made that the repeater has data to transmit to the server.

30. The method of claim 23, further comprising:
determining whether a version of control software in the repeater is outdated; and
updating the repeater with new control software.

31. The method of claim 23, wherein the updating step includes:
transmitting the new control software from the server to the repeater over the first link.

32. The method of claim 23, further comprising:
disconnecting the first link when a disconnection request is issued.

33. The method of claim 23, further comprising:
checking whether data has been transmitted between the server and repeater within a predetermined standby time; and
automatically disconnecting the first link when no data has been transmitted during the standby time.

34. A method for controlling a repeater in a mobile communication system, comprising:
establishing a link between a server and the repeater based on an internetworking function performed with a mobile communication network; and
transmitting control information between the server to the repeater over the link.

35. The method of claim 34, wherein the server initiates establishing the link.

36. The method of claim 34, wherein the establishing step includes:
transmitting a connection request message as an SMS message to the repeater over the link; and
connecting the link based on a response from the SMS message.

37. The method of claim 34, wherein the establishing step includes:
transmitting a connection request message as a ring signal through a modem to the repeater over the link; and
connecting the link based on a response from the ring signal.
